(19) United States
(12) Patent Application Publication
(10) Pub. No.: US 2018/0092491 A1
(43) Pub. Date: Apr. 5, 2018

(54) CONDITION INDICATING TOASTER RELEASE MATERIAL

(71) Applicant: LEDK, Inc., Metter, GA (US)

(72) Inventor: Jerry Michael Kohout, Metter, GA (US)

(21) Appl. No.: 15/721,075

(22) Filed: Sep. 29, 2017

Related U.S. Application Data
(60) Provisional application No. 62/402,528, filed on Sep. 30, 2016.

(51) Int. Cl. A47J 37/08

(52) U.S. Cl. CPC A47J 37/0885

(57) ABSTRACT

A toaster release material configured to at least partially cover a platen in a toaster oven and to provide a nonstick cooking surface is provided. The toaster release material includes a base layer substrate supporting one or more nonstick layers. The one or more nonstick layers include a nonstick warning layer for cooking coated on the base layer and a nonstick exterior layer for cooking coated on the warning layer. During use in a toaster over where the toaster release material is subjected to heat, the exterior layer deteriorates such that at least a portion of the warning layer having a different color than the exterior layer is exposed to provide a visual indication of the remaining lifespan of the toaster release material.

### PRIORITY CLAIM

This application claims priority to U.S. Provisional Patent Application No. 62/402,528, filed Sep. 30, 2016, and entitled “CONDITION INDICATING TOASTER RELEASE MATERIAL,” the disclosure of which is hereby incorporated by reference in its entirety.

### BACKGROUND OF THE INVENTION

### Field of the Invention

Various embodiments of the present invention generally relate to toaster release materials, and, in particular, to a toaster release material configured for indicating its condition to a user.

### Description of Related Art

Toaster release materials, such as toaster release sheets and toaster release belts, are frequently used as a non-stick surface in the restaurant and food service industry. For example, toaster release materials are often placed in commercial toaster ovens to protect buns, toast, and other objects from sticking to the toaster oven's platen while these products are being heated. These toaster release materials can be embodied as a thin, flat sheet that rests on the toaster oven's platen or as a belt that rotates within an oven during operation.

Over time, the toaster release material may wear down or otherwise deteriorate, thereby requiring the toaster release material to be replaced. However, existing toaster oven materials are not capable of effectively indicating their condition to a user. Rather, the user can only keep track of how long the toaster release material has been in use and calendar a date for replacement. This is inconvenient and increases the likelihood that a release material may be used beyond its intended lifespan. Moreover, the condition of the toaster release material may require replacement before or after a calendared date on account of the frequency or other circumstances of the material's use.

Accordingly, there is an ongoing need in the art for a toaster release material capable of indicating to a user that its condition requires it to be replaced.

### BRIEF SUMMARY OF THE INVENTION

Various embodiments of the present invention provide for a toaster release material for at least partially covering a platen in a toaster oven and for providing a nonstick cooking surface. In certain embodiments, the toaster release material includes a base layer substrate, a nonstick warning layer, and a nonstick exterior layer. The nonstick warning layer includes a nonstick material coated on the base layer substrate for providing a nonstick cooking surface when exposed, and the nonstick exterior layer includes a nonstick material coated on the nonstick warning layer for providing a nonstick cooking surface. In certain embodiments, the nonstick exterior layer deteriorates during use of the toaster release material in order to expose the nonstick warning layer. A portion of the nonstick warning layer that has a different color than the nonstick exterior layer provides a visual indication of the remaining lifespan of the toaster release material when the nonstick warning layer is exposed.

In some embodiments, the toaster release material is formed such that the base layer substrate, the nonstick warning layer, and the nonstick exterior layer form a thin sheet that rests on the platen in the toaster oven. In such an embodiment, the thin sheet defines a rectangular outer perimeter.

In certain embodiments, the base layer substrate includes a woven fiberglass cloth material and the nonstick material forming the nonstick exterior layer and the nonstick warning layer includes polytetrafluoroethylene (“PTFE”). In some embodiments, the thickness of the nonstick exterior layer is greater than the thickness of the nonstick warning layer.

In other embodiments, the toaster release material is formed such that the base layer substrate, the nonstick warning layer, and the nonstick exterior layer form a thin belt having a diameter, a width, and an overall thickness.

In certain embodiments, the toaster release material includes one or more attachment features for securing the toaster release material to the platen of the toaster oven. In other embodiments, the toaster release material is draped over the platen of the toaster oven such that one more free ends of the toaster release material are secured to one another.

In some embodiments, the nonstick warning layer includes a first nonstick warning layer coated on a first side of the base layer substrate and the nonstick exterior layer includes a first nonstick exterior layer coated on the first nonstick warning layer. In such an embodiment, the toaster release material further includes a second nonstick warning layer including a nonstick material coated on a second side of the base layer substrate for providing a nonstick cooking surface when exposed. The toaster release material also includes a second nonstick exterior layer including a nonstick material coated on the second warning layer for providing a nonstick cooking surface. The second nonstick exterior layer deteriorates during use of the toaster release material in order to expose the second nonstick warning layer. Additionally, at least a portion of the second nonstick warning layer has a different color than the second nonstick exterior layer to provide a visual indication of the remaining lifespan of the toaster release material when the second nonstick warning layer is exposed.

In certain embodiments, the nonstick exterior layer is formed entirely with a first color and the nonstick warning layer is formed entirely with a second color, and the second color is different from the first color.

### BRIEF DESCRIPTION OF THE SEVERAL VIEW OF THE DRAWINGS

Reference will now be made to the accompanying drawings, which are not necessarily drawn to scale and wherein:

FIG. 1 shows a perspective view of a toaster release sheet according to one embodiment of the present invention;

FIG. 2 shows a cut-away side view of a toaster release sheet according to one embodiment of the present invention;

FIG. 3 shows a cut-away side view of a toaster release sheet according to one embodiment of the present invention; and

FIG. 4 shows a perspective view of a toaster release belt according to one embodiment of the present invention.

### DETAILED DESCRIPTION OF THE DRAWINGS

The present invention will now be described more fully hereinafter with reference to the accompanying drawings, in which some, but not all embodiments of the invention are shown. Indeed, the invention may be embodied in many different forms and should not be construed as limited to the embodiments set forth herein. Rather these embodiments are provided so that this disclosure will satisfy applicable legal requirements. Like numbers refer to like elements throughout.

### Overview

Various embodiments of the present invention are directed to a toaster release material configured for indicating its condition to a user. Toaster release materials, such as toaster release sheets and belts, are generally used in conjunction with commercial toasters, such as vertical contact toasters, as a non-stick covering for the toaster's hot platen during the heating process. Over time, the condition of the toaster release material may deteriorate and the toaster release material may need to be replaced. As an example, a non-stick coating provided on the toaster release material may wear away after a period of use, rendering the release material less effective. For example, the non-stick coating on the toaster release material may wear away from friction with other components present in the toaster, the removal of the outer layers due to the effects of heat, and/or any other means related to use in a commercial toaster oven. In order to alert the user that the toaster release material's condition necessitates its replacement, the toaster release material described herein is provided with a warning layer configured to visually indicate to the user the condition of the toaster release material.

According to various embodiments, the condition indicating toaster release material generally comprises a base layer coated with a number of non-stick layers. In particular, the non-stick layers may include an outer non-stick layer and at least one warning non-stick layer. Contrasting colors of non-stick material are used such that the outer layer may be a neutral color (e.g., one which is standard in the industry, such as black) and the at least one warning layer may be a contrasting color to alert the user of the material's condition (e.g., yellow or orange). As the outer non-stick layer wears off of the toaster release material during use, the warning layer is revealed thereby visually indicating the condition of the toaster release material. As described herein, the relative thickness of the non-stick layers may be such that the warning non-stick layer remains concealed for a substantial portion of the toaster release material's useful life and, when the outer non-stick layer has worn away and reveals the warning non-stick layer, the toaster release material can still be used for a shorter period of time to allow for replacement of the toaster release material.

As explained in greater detail herein, some embodiments of the toaster release material may be configured as a flexible sheet adapted for placement on a toaster platen (e.g., a generally flat, flexible, single piece of toaster release material dimensioned to fit in a commercial toaster oven). In other embodiments, the toaster release material may take the form of a belt (e.g., a continuous loop of material) having one or more fasteners (e.g., snaps) such that the toaster release belt may wrap around the platen and the one or more fasteners may be positioned in a groove to avoid movement of the material during use. Various embodiments of the toaster release material hereinafter described may be utilized in various commercial toaster ovens and grills including but not limited to clamshell, diagonal contact conveyer, dual continuous feed, dual belt, vertical contact, electric griddle top toasters/grills. Additionally, the present invention contemplates that a single commercial toaster may utilize multiple toaster release materials (e.g., sheets and/or belts) depending upon the design of the toaster. As will be appreciated from the detailed description of various embodiments below, the configurations of the condition indicating toaster release material enables users to identify the current condition of a toaster release material to ensure that the sheets or belts are not used beyond an intended lifespan.

### Condition Indicating Toaster Release Sheet

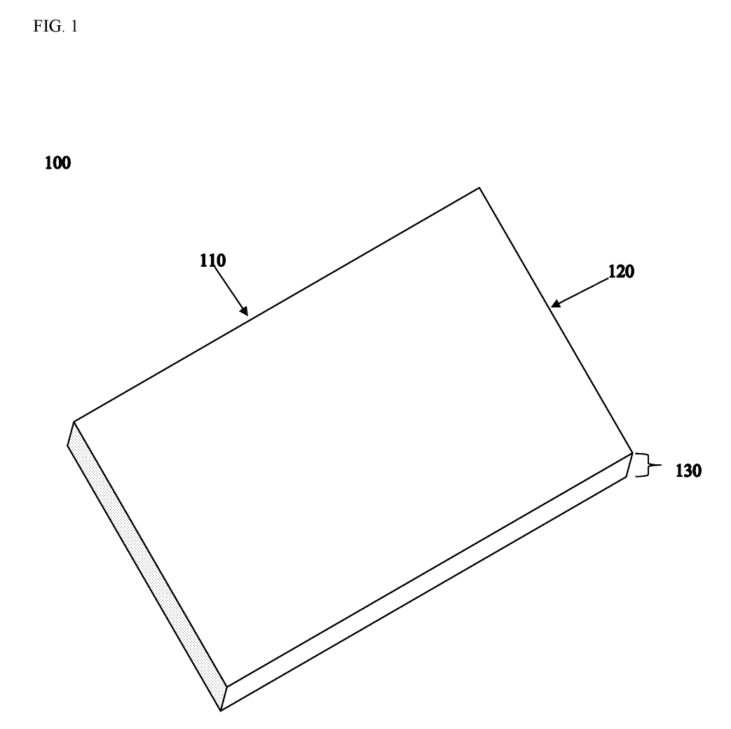

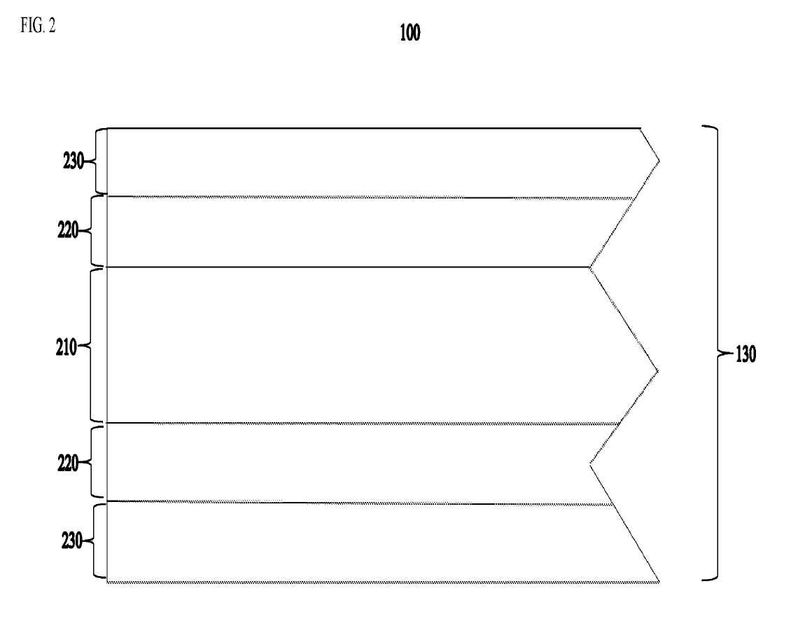

FIG. 1 illustrates a condition indicating toaster release sheet according to one embodiment. As illustrated in FIG. 1, the condition indicating toaster release sheet 100 is shown in an unrolled, substantially flat configuration and defines longitudinal edges 110, width-spanning edges 120, and an overall thickness 130. According to various embodiments, the toaster release sheet 100 generally comprises a base layer 210 coated with warning layers 220 and outer layers 230. For example, FIG. 2 illustrates a schematic, cross-sectional side view of the toaster release sheet 100 according to one embodiment. As shown in FIG. 2, the base layer 210 is located in the center of the cross section of the toaster release sheet 100 and a warning layer 220 and outer layer 230 are provided on both faces of the release material's base layer 210. In particular, in the illustrated embodiment of FIGS. 1 and 2, the warning layers 220 fully cover the faces of the base layer 210, while the outer layers 230 fully cover the warning layers 220.

In the illustrated embodiment, the base layer 210 comprises a substrate of thin woven fiberglass cloth suitable for use in a commercial oven environment and configured to support the non-stick warning layers 220 and the non-stick outer layers 230. However, as will be appreciated from the description herein, the base layer 210 could be constructed from other suitable toaster release substrate materials (e.g., thin, heat-resistant fabrics or other materials). In addition, the base layer 210 may be of any thickness suitable to meet the needs of its intended application. As one example, certain embodiments of the base layer 210 may have a thickness between approximately 0.001 inches to 0.030 inches.

In the illustrated embodiment, the non-stick warning layers 220 each comprise a layer of Polytetrafluoroethylene (“PTFE”) material coated on a face of the base layer 210. In one embodiment, the non-stick warning layers 220 are colored to contrast with the color of the outer layers 230. For example, in one embodiment, the non-stick warning layers are comprised of an orange-colored PTFE material, while the outer layer is colored black. Other colors, e.g., green, yellow, red, purple, blue, or others, could similarly be used.

The non-stick outer layers 230 also comprise a layer of PTFE material which is coated on the warning layers 220 to provide a non-stick outer surface for use in a commercial oven. In various embodiments, the non-stick outer layers 230 may be colored black or another color contrasting with the warning layers 220. As will be appreciated from the description herein, other non-stick coatings suitable for use in a commercial oven environment may be used to form the non-stick outer and warning layers 230, 220.

In order to coat the non-stick layers 220, 230, the base layer 210 may be immersed in a liquid non-stick material (e.g., PTFE) to create non-stick layers 220, 230 coated on the base layer 210. In particular, the base layer may be immersed multiple times in a liquid non-stick material until the toaster release material reaches the desired thickness depending upon its application.

The non-stick warning layer 220 may be of any thickness required by the intended application. As discussed above, the warning layer 220 may be provided with a thickness such that an adequate warning period is provided to the user during which a replacement toaster release sheet may be located and installed. This enables the user to replace the toaster release sheet 100 before the warning layer 220 wears away and leaves the base layer 210 exposed. The thicker the warning layer 220 is, the greater this warning period will be. In certain embodiments, for example, the thickness of the non-stick warning layer is between approximately 0.0005 inches to 0.01 inches.

Similarly, the non-stick outer layer 230 may be of any thickness required by the intended application. As discussed above, the outer layer 230 may be provided with a thickness such that a substantial portion of the toaster release sheet's useful life is expired before the outer layer 230 wears away to reveal the warning layer 220. The thicker the outer layer 230 is, the greater this initial use period will be. In one embodiment, for example, the thickness of the non-stick outer layer is between approximately 0.0005 inches to 0.01 inches.

The overall thickness 130 of the toaster release sheet 100 may be of any thickness based upon the required longevity for the intended application. For example, in the illustrated example configured for application in the food service industry, the overall thickness 130 is between 0.003 inches and 0.04 inches for use with commercial vertical contact toaster ovens.

As noted above, the release sheet is configured to have a length (along the longitudinal edges 110), a width (along the width edges 120), and an overall thickness 130 such that the toaster release sheet 100 fully covers a platen in a commercial toaster oven. It may be appreciated that the length 110, width 120, and overall thickness 130 dimensions may be adapted to an intended application of the toaster release sheet 100. As such, the toaster release sheet 100 may be provided in a circle, oval, rectangle, square, triangle, rhombus, trapezoid, or other shape for use in conjunction with various designs and configurations of toaster ovens.

A toaster release sheet 100 as shown in FIG. 1 is flexible such that the sheet may fold to cover both sides of a platen in a vertical contact toaster as would be understood by one of ordinary skill in the art in light of the present disclosure. In the illustrated embodiment, the toaster release sheet 100 may be folded about an axis generally in the center of the release sheet such that the release sheet may be draped over a platen and the free ends secured to one another or to the platen. In order to achieve this flexibility, the present disclosure contemplates that a maximum value for the overall thickness 130 of the toaster release sheet 100 may be necessary to ensure flexibility in some applications.

As discussed above, the outer non-stick layer 230 wears down from during use of the toaster release sheet 100 and, eventually, the non-stick warning layer 220 becomes visible to the user. In this way, the toaster release sheet 100 visibly indicates its condition to the user. For example, where the non-stick outer layer 230 is black and the warning layer 220 is orange, as long as the surface of the toaster release sheet 100 appears black, the user is informed that the release sheet has a substantial duration of useful life yet. However, when the surface of the toaster release sheet 100 appears orange, the user is informed that the release sheet should be replaced and is near the end of its useful life.

As may be understood by one of ordinary skill in the art in light of the present disclosure, many modifications to the illustrated toaster release sheet 100 are contemplated by the present disclosure. For example, as will be appreciated by the nature of the use of a toaster release sheet 100, the present disclosure contemplates that in alternative embodiments, the warning layer 220 and the outer layer 230 may only be applied to one face of the base layer 210.

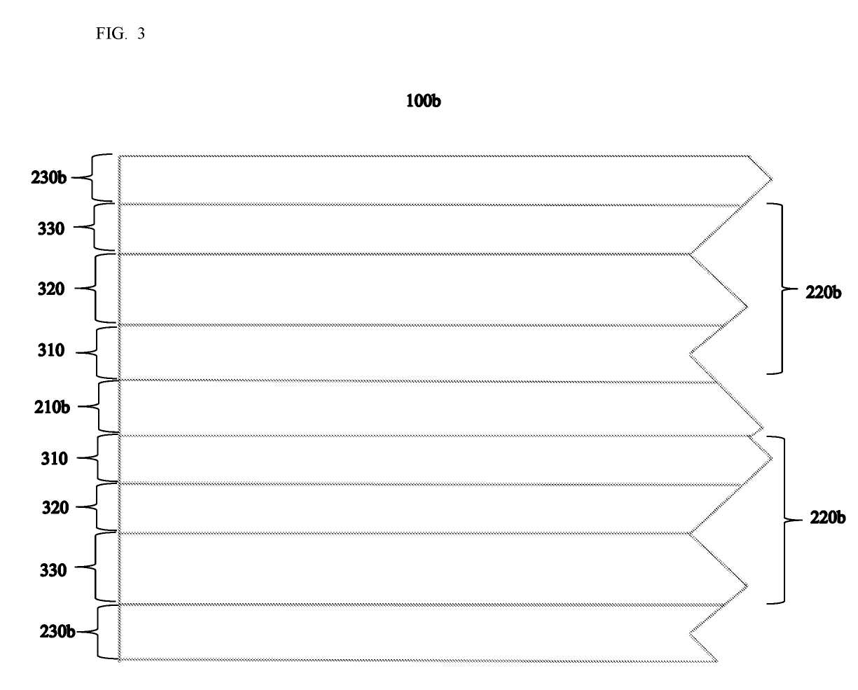

In addition, FIG. 3 illustrates a cross-sectional side view of a toaster release sheet 100b according to another embodiment. Although the above-description of the toaster release sheet 100 shown in FIGS. 1 and 2 applies generally to the toaster release sheet 100b, the toaster release sheet 100b has a warning layer 220b comprised of multiple layers, each with a different color. For example, in one embodiment, the outer most warning layer 330 is colored yellow, the middle warning layer 320 is colored orange, and the inner warning 310 is colored red. In such an embodiment, the different colored warning layers show a progression of wear such that a user may more accurately identify the current condition of the toaster release sheet 100b as the warning layers wear away. As will be appreciated from the description herein, any number of condition-indicating colored warning layers may be provided on the toaster release sheet. As will be appreciated from the disclosure herein, the non-stick layers of FIG. 2 may also be provided on a single face of the base layer 210b according to various embodiments.

Further, various embodiments of the toaster release sheet 100 may also be provided with a large length 110 to width 120 ratio such that a single large release sheet may be stored as a single roll. In such an embodiment, individual toaster release sheets may be cut from a single roll to a particular size for an intended use. In such a large roll embodiment, perforations may be utilized across the width of the release sheet at various lengths to allow for sheets of a set size to be stored in a roll and removed by tearing or cutting along the perforation.

As will be appreciated by nature of the use of the toaster release sheet 100, the present disclosure contemplates that the toaster release sheet shown in FIGS. 1-3 may be subject to cleaning supplies to ensure the safety of consumers in markets such as the food service industry. In some embodiments, the material of the exterior of the toaster release sheet may be such to provide easy cleaning of the surface by the user. By way of example, the outer layer 230 shown in FIG. 2, may be made of a water repellant and easy to clean material that is resistant to stains and harsh abrasive cleaning products.

As will also be appreciated by the nature of the use of the toaster release sheet 100, the present disclosure contemplates that the toaster release sheet shown in FIGS. 1-3 may be constructed of a materials which can operate at high temperatures. In some embodiments, the toaster release sheet may be constructed of materials that may safely withstand temperatures in a range of −100° F. to 550° F. By way of example, the toaster release sheet 100 in FIGS. 1-3 may operate at a temperature of 450° F. and therefore may be constructed of a material which may operate safely at that temperature.

### Condition Indicating Toaster Release Belt

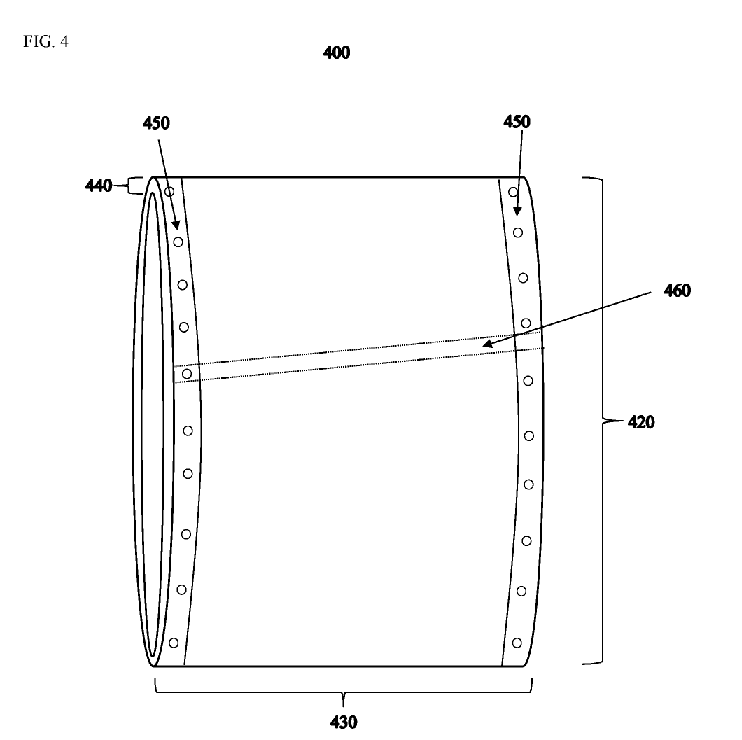

FIG. 4 illustrates a toaster release belt 400 according to one embodiment. Various embodiments of the toaster release belt 400 include the same base layer and non-stick layers (and their associated characteristics) described above in relation to various embodiments of the toaster release sheet described above. Indeed, the descriptions above with respect to FIGS. 1-3 also apply to the toaster release belt 400. Accordingly, it will be understood that the toaster release belt 400 will provide the same condition-indicating function as the embodiments of the toaster release sheet described above.

However, as shown in FIG. 4, the toaster release belt 400 is configured as a flexible continuous loop of toaster release material (in contrast to the single sheet comprising to the above-described toaster release sheet 100). In particular, as shown in FIG. 4, the toaster release belt 400 defines a diameter 420, a width 430, an overall thickness 440. As will be appreciated from FIG. 4, the toaster release belt 400 can be formed by the attachment of two edges of a toaster release sheet, thereby creating a seam 460 where the two ends of the sheet are joined and overlap. This attachment may be accomplish by any suitable method (e.g., adhesive, heat sealing, stitching, among others).

The toaster release belt 400 also includes attachment features 450 configured to enable the toaster release belt 400 to be secured to a platen in a vertical contact toaster. As shown in FIG. 4, the attachment features 450 are provided along the lateral edges of the toaster release belt 400. According to various embodiments, the attachment features 450 allow for the toaster release belt 400 to be placed around and secured to the entire platen to ensure continuous contact. For example, in one embodiment, the attachment features 450 comprise an array of stud (e.g., male fastener end) snap fasteners aligned around both edges of the release belt. In such an embodiment, the stud snap fasteners engage sockets (e.g., female fastener end) snap fasteners located on a platen in a vertical contact toaster. In another embodiment, for example, the snap fasteners may be positioned within a groove defined by the toaster. In such an embodiment, the snaps (e.g., male fastener end) may be positioned within a groove defined by one or more surfaces of the toaster such that the toaster release belt is secured during operation.

According to various embodiments, the release belt 400 is dimensioned to fully cover a platen in a vertical contact commercial toaster oven. However, as will be appreciated from the description herein, the diameter 420, width 430, and overall thickness 440 may be of any dimensions suitable for an intended application of the toaster release belt 400. Indeed, the overall thickness 440—as well as the thicknesses of the base and non-stick layers defining the belt 400—may be the same as those described above in relation to various embodiments of the toaster release sheet and may be adjusted depending on a particular application.

As may be understood by one of ordinary skill in the art in light of the present disclosure, many modifications to the illustrated toaster release belt 400 are contemplated by the present disclosure. Although the illustrated toaster release belt is depicted as a continuous loop with straight edges, various edges, shapes, and configurations may be used depending on the belt's intended application. Although the illustrated toaster release belt 400 depicts snap fasteners in FIG. 4, the present disclosure contemplates any suitable attachment mechanism 450 (e.g., fasteners, buttons, rivets, tabs, hook and loop, adhesives, among others). Further, although the present invention is described in reference for use in the food service industry in conjunction with a commercial toaster over, the present disclosure contemplates that wear indicating release materials may be utilized in a number of industries including the carpet and fiber industry.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed is:

1. A toaster release material configured to at least partially cover a platen in a toaster oven and to provide a nonstick cooking surface, the toaster release material comprising:
a base layer substrate;
a nonstick warning layer comprising a nonstick material coated on the base layer substrate and configured for providing a nonstick cooking surface when exposed; and
a nonstick exterior layer comprising a nonstick material coated on the nonstick warning layer and configured for providing a nonstick cooking surface;
wherein the nonstick exterior layer is configured to deteriorate during use of the toaster release material in order to expose the nonstick warning layer and wherein at least a portion of the nonstick warning layer has a different color than the nonstick exterior layer to provide a visual indication of the remaining lifespan of the toaster release material when the nonstick warning layer is exposed.

2. The toaster release material according to claim 1, wherein the toaster release material is formed such that the base layer substrate, the nonstick warning layer, and the nonstick exterior layer form a thin sheet configured to rest on the platen in the toaster oven.

3. The toaster release material according to claim 2, wherein the thin sheet defines a rectangular outer perimeter.

4. The toaster release material according to claim 1, wherein the base layer substrate comprises a woven fiberglass cloth material.

5. The toaster release material according to claim 1, wherein the nonstick material forming the nonstick exterior layer and the nonstick warning layer comprises polytetrafluoroethylene (“PTFE”).

6. The toaster release material according to claim 1, wherein the thickness of the nonstick exterior layer is greater than the thickness of the nonstick warning layer.

7. The toaster release material according to claim 1, wherein the toaster release material is formed such that the base layer substrate, the nonstick warning layer, and the nonstick exterior layer form a thin belt having a diameter, a width, and an overall thickness.

8. The toaster release material according to claim 1, wherein the toaster release material further comprises one or more attachment features configured to secure the toaster release material to the platen of the toaster oven.

9. The toaster release material according to claim 1, wherein the toaster release material is configured to be draped over the platen of the toaster oven such that one more free ends of the toaster release material are secured to one another.

10. The toaster release material according to claim 1, wherein the nonstick warning layer comprises a first nonstick warning layer coated on a first side of the base layer substrate and the nonstick exterior layer comprises a first nonstick exterior layer coated on the first nonstick warning layer, and
wherein the toaster release material further comprises:
a second nonstick warning layer comprising a nonstick material coated on a second side of the base layer substrate and configured for providing a nonstick cooking surface when exposed; and
a second nonstick exterior layer comprising a nonstick material coated on the second warning layer and configured for providing a nonstick cooking surface;
wherein the second nonstick exterior layer is configured to deteriorate during use of the toaster release material in order to expose the second nonstick warning layer and wherein at least a portion of the second nonstick warning layer has a different color than the second nonstick exterior layer to provide a visual indication of the remaining lifespan of the toaster release material when the second nonstick warning layer is exposed.

11. The toaster release material according to claim 1, wherein the nonstick exterior layer is formed entirely with a first color and the nonstick warning layer is formed entirely with a second color, wherein the second color is different from the first color.
